(19) United States
(12) Patent Application Publication
(10) Pub. No.: US 2023/0287916 A1
(43) Pub. Date: Sep. 14, 2023

(54) Composite Fastener

(71) Applicant: C. dec bv, De Panne (BE)

(72) Inventor: Claire DECOENE, De Panne (BE)

(73) Assignee: C.dec bv, De Panne (BE)

(21) Appl. No.: 17/810,045

(22) Filed: Jun. 30, 2022

(30) Foreign Application Priority Data
Mar. 9, 2022 (BE) 2022/5161

(51) Int. Cl. F16B 5/07

(52) U.S. Cl. CPC F16B 5/07

(57) ABSTRACT

The invention concerns an improved means of joining two surfaces with flexible elements on them that, when the two surfaces are placed against each other, grip each other clampingly.

### INTRODUCTION

The present invention concerns a fastener consisting of two components that can connect each other in a non-permanent manner. The operation is like a hook and loop fastener but has a clear technical difference.

### STATE OF THE ART

The so-called hook and loop fastener are the most well-known quick closures, which intend to connect two components.

The generic trademark Velcro often refers to these hook and loop fasteners because of the brand's prominence.

Hook and loop fasteners consist of two components: typically, two linear fabric strips (or, alternatively, round “dots” or squares) that are attached (sewn or otherwise sutured) to the facing surfaces to be attached. The first part is provided with small brackets; the second has smaller loops. When the two are pressed together, the hooks get stuck in the loops, and the two click elements are temporarily fastened or bound. When separated, the strips make a characteristic tearing sound by pulling the two surfaces apart or peeling them off.

Mr. George De Mestral invented the original technique of hook and loop fastener. He applied for a patent CH295638A in 1951 with Velcro SA as the applicant.

This hook and loop technique has some specific advantages and disadvantages.

The advantages are that it is quite efficient and is now a well-known technique. It is also washable, which makes it relatively long to keep clean.

However, there is also a range of drawbacks to it. It is expensive to make, over time, it loses its effect, and it tends to accumulate hair, dust, and fur in the hooks after a few months of regular use. The loops can become elongated or broken after prolonged use. The hooks are often attached to garments, especially loosely woven items such as sweaters. These clothes can be damaged when one tries to remove the hook and loop fastener, even if the sides are slowly separated. It also absorbs moisture and perspiration when worn on the skin, which means it will smell if not washed.

In addition to Velcro's original hook and loop fastener, there are also some variations on the market. The Slidingly Engaging Fastener is designed to address various issues with common hook and loop fasteners. Heavy-duty variants have mushroom-shaped stems on each plane of the clasp, which give an audible click when the two planes fit together. In addition, a strong pressure-sensitive adhesive adheres each part to its substrate.

### SUMMARY

The present invention and versions thereof offer a solution to one or more of the disadvantages mentioned earlier. To this end, the present invention relates to composite fasteners and processes as described in the claims and further below.

The present invention relates in the first aspect to composite fasteners consisting of at least a first click element or carrier and a second click element or carrier, at least wherein the first click element comprises pins provided on at least one side, the coupling surface, and an opposite second click element that contains at least pins comprises provided on at least one side, the coupling surface, and wherein the two click elements can click together. The click elements or carriers comprise a coupling surface wherein many pins are provided, preferably in a regular grid pattern, preferably with equidistant rows and columns so that they are provided in a regular matrix pattern, typically rectangular or square. The pins comprise at least one anchoring segment along the longitudinal axis, which has a greater radius than an underlying segment (recess), and, optionally, a larger radius than an overlying segment (recess or pin top). The pins are preferably made of a flexible material

Here the pins of the first carrier are distanced from each other at rest so that the anchoring segments of the pins of the first carrier have a distance between them which define a free space between the anchoring segments in the plane parallel to the first carrier where a transverse cross-section of the anchoring segments of the pins of the second carrier does not fit in. In addition, they have distanced from each other in such a way that the underlying segments of the pins of the first carrier at rest define a space between the underlying segments in the plane parallel to the first carrier where a transverse cross-section of the anchoring segments of the pins of the second carrier does fit in, such that when the first and second carrier are brought together with the coupling surfaces facing each other, the pins hold each other clampingly.

According to a certain preferred design, the click elements comprise at least one coupling surface with many pins on top, preferably in a regular grid pattern, preferably with equidistant rows and columns so that they are provided in a regular matrix pattern, typically rectangular or square.

The pins comprise at least one anchoring segment along the longitudinal axis, which has a greater radius than an underlying segment (recess), and, optionally, a larger radius than an overlying segment (recess or pin top). The pins are preferably made of a flexible material.

The pins are distanced from each other on the carriers (click elements) such that the anchoring segments of the pins of the first carrier have a distance between them equal to or greater than the pins at the recesses (underlying and optional overlying segments) but smaller than the radius of the anchoring segments of the pins of the second carrier, such that when the two carriers are brought together with the coupling surfaces facing each other, the pins hold each other clampingly.

The shape of the pins must be considered. For example, with square transverse cross-sections, a different interaxial distance must be counted on than with disc-shaped transverse cross-sections of the pins.

“Transverse cross-sections” refers to cross-sections of the pins in a plane perpendicular to the lengthwise axis or longitudinal axis of the pins. Depending on the specific shape of the cross-section, the dimensions of the anchoring segments and the recesses below can be adjusted to ensure successful anchoring. In addition, the dimensions can also be further adjusted (more significant difference between the radius of anchoring segments and recesses) to obtain a more substantial or (smaller difference) to obtain a weaker connection.

According to a preferred embodiment, the click elements are periodically provided with a series of pins that are provided with a set of protrusions or anchoring segments (also called ribs) and recesses below on the side, with the protrusions of the pins of the first click element adjusted to match the recesses under the anchoring segments of the pins of the second click element and vice versa, and preferably so that they fit into the recesses of the pins of the second click element and the protrusions of the second click element into the recesses of the first click element fit. In what follows, these recesses are also referred to as a overlying, underlying, or intermediate segments relative to the ribs (or protrusions or anchoring segments).

According to a preferred embodiment, the first and/or second carriers are flexible. Preferably, the carriers and pins on them are single-piece, allowing, for example, manufacture via 3D printing, injection molding, or other automated processes.

According to a preferred embodiment, the pins have multiple anchoring segments, with segments (recesses) with a lower radius in between. Preferably, all anchoring segments have substantially the same shape and dimensions and the recesses in relation to each other.

The general principle of the present invention is a method in which the pins of two different click elements exert a clamping effect on each other to obtain a clamping effect between the replaced click elements.

According to one aspect of the invention, the quick closure is formed by clicking two identical click elements together. This contains a base consisting of a plastic plate with pins on one side, wherein the sides of these pins are provided with recesses. These recesses have the shape of a barb. The hooks of these barbs are directed towards the surface of the base, with the function of the barb being active in the direction away from the surface and perpendicular to the surface of the base plate. Preferably, barbs are provided at the corners of the anchoring segments, as also visible in FIG. 1. In addition, by suitable positioning of the barbs, it can be ensured that the barbs of the pins of a first click element for two anchored click elements at rest, coincide with the barbs of the pins of the second click element, and thereby hooking together. The number of recesses is at least one per side, but preferably two, three, or even more. The pins can be square in shape, with the top beveled and/or rounded. These pins are at a certain distance from each other via an ordered pattern. This distance is equal in the x and y directions. The axis distance of the different pins is preferably equal to the distance of the maximum side or diameter of the pins increased by 50%, making it possible to link two click elements with each other. The height of the pins are preferably equal to the axis distance of the pins but can be longer or shorter depending on the desire for a stiffer or more flexible coupling. The sides of the adjacent pins are positioned in parallel with respect to each other. The intention is to apply the click elements that are identical to each other as a quick release. Two identical click elements are placed on top of each other with the top sides of the pins facing each other, with one click element rotated 45° in relation to the other click element in such a way that the pins of the one click element are rotated 45° around their longitudinal axis in relation to the pins of the second click element when brought together for linking. The two click elements are then pressed together. Since the one click element is rotated 45° in relation to the other click element, the patterns of the two click elements do not match. As a result, some pins of the one click element push the pins of the other click element away to a certain angle, those other pins hook into each other without or almost do not push each other away, and some pins do not actively hook into other pins. With the (barb) hooks or ribs on the side of the pins, the protrusions are smaller than the recesses of the corresponding pins of the other click element in which they hook in. In this version, the two click elements can be connected to each other in any place. A connection can also be made that has a curved shape in the basic direction.

Another aspect of the invention is that the quick closure is formed by clicking two different click elements together. The first click element contains a base consisting of a plastic plate with pins on one side, wherein the sides of these pins are provided with recesses and ribs anchoring segments. These recesses are in conjunction with the anchoring segments equipped with one or more barbs. The hooks of these barbs are directed towards the surface of the base, wherein the function of the barb is active when the retained element moves in the direction away from the surface (and perpendicular to the surface) of the base plate.

The number of recesses is at least one per side, but preferably two, three or even more. The pins can be square in shape, with the top beveled and/or rounded. These pins are at a certain distance from each other via an ordered pattern. This distance is preferably essentially equal in the x and y directions. The interaxial distance between directly adjacent pins (closest pins) is preferably at least 2.0 times the minimum radius of the anchoring segments, preferably at least 2.10 times the minimum radius, and preferably at least 2.25 times to even at least 2.5 times. This ensures a certain resistance between the anchoring segments when the pins of click elements are brought past each other.

Preferably this interaxial distance is a maximum of 4.0 times the minimum radius, but preferably this is lower, namely a maximum of 3.5 times, or (2+√2) times the minimum radius. With the most obvious preference, it is a maximum of 3 or 2.5 times the minimum radius. By limiting this, it is ensured that once the pins of the click elements are linked (with the anchoring segments that are moved past each other), they cannot simply be disconnected due to the lateral forces that the pins exert on each other.

The interaxial or axis distance of the different pins is preferably equal to the distance of the maximum size of the pins plus 50%. The height of the pins is preferably equal to the axis distance of the pins but may vary depending on further requirements.

In a preferred embodiment, the pins are provided with two or more ribs or anchoring segments on top of each other, making it possible to anchor the click elements to each other on multiple levels, thus obtaining a more robust and more reliable attachment.

In a preferred embodiment, the anchoring segments have a larger minimum radius than the maximum radius of the underlying segments. This guarantees a firm anchoring under any relative orientation.

The adjacent sides of the pins are arranged in parallel to each other. The second click element is similar in execution to the first click element, wherein the pins are provided in the same pattern but are rotated at an angle of 45° around their own axis, so the adjacent pins are facing each other with the angular sides (with the pins of the first click elements with the sides facing each other).

The intention is to apply the two different parts as a quick closure. Two different click elements are placed on top of each other, with the header sides of the pins facing each other, wherein the pins of the one click element fit between the pins of the other click element. Then, the two click elements are then pressed together. Since the pins of the second click, element is rotated 45° in relation to the first click element, but the patterns of the two click elements do match, the pins will be fixed in the free spaces. Each pin will be clamped by a pin of the other click element in the middle of each side of it. With this arrangement, almost all pins remain upright. In this version, only connections can be realized with an interval equal to the interaxial distance or axis distance between the different pins. Also, no connection can be made that has a pronounced curved shape.

However, under certain adaptations, curved connections are enabled, for instance by increasing the distance between the pins according to a first axis in the plane of the grid pattern, allowing the carriers to be connected under a curved shape, with the curve being along said first axis (i.e., curved around a second axis in the plane of the grid pattern, perpendicular to the first axis).

Alternatively (or building further on the above), the carriers can be connected after being heated slightly, to increase their deformability/elasticity. Once the connection is established, the carriers will return to a lower temperature (naturally or artificially) and set themselves in a strong connection.

The adhesion between the different click elements is optimal if the recesses have the shape and function of barbs. However, in the setups described in the previous versions, it is very complex and expensive to form the pins by forming them directly with injection molds or other techniques that use molds to form the recesses in the sides of the pins.

According to an alternative technique, the recesses are formed after the pins themselves are formed after they have been removed from the molds. The recesses in the side of the pins or even the shape of the pins themselves can be formed in a second phase by using machining tools that pass along the sides of the pins, and machining parts of the pins, by using, for example, small chisel-shaped tools where a piece of the pins can be removed in several steps so that they form the desired recesses such as forming the barb. This is possible for the different shapes as described in the previous versions.

According to another aspect of the invention, the pins may have a different shape than squares in terms of a transverse cross-section. These can be round, triangular or polygonal (preferably regular polygons, especially hexagonal or octagonal) in general. In height, the base shape of the pins can be straight, conical, inverted conical, or any other arbitrary shape. However, the preferred shape is to make it slightly conical with a minimum angle of 0-10°, preferably 0.5°-5° or even 1°-2°, to make it easier to remove the shape from the production mold after injection molding.

Preferably, the width-height ratio of the pins is a ratio that is between one to two and one to three of the diameter or side in the base of the pin to the height.

The top of the pin is preferably rounded or at least beveled so that the pins of the opposing click elements can push each other away if they touch each other on the ends and can, therefore, more easily interlock. Preferably the same applies to the top of lower ribs or anchoring segments for the same reason.

According to another aspect of the invention, the two click elements may be identical in a pattern when hooking together. Here, the center points of the pins are equally far from each other according to the same pattern. When hooking in the two click elements, the pins are not or hardly pushed away from each other, but the protrusions of the pin of the one click element hook into the recesses of the other click element and vice versa. In the version where the pins have a square shape, the pins of the opposite click element should be rotated 45° around their axis, but the same pattern is used. This has the effect that when clicking the two click elements together, the angular sides of the pin of one click element press into the lateral sides of the other pins. This gives a point load that makes it possible for the pins to be pressed together with a compressive force and pulled back apart with a tensile force, which is workable for its applications as is now applied in the current so-called hook and loop fastener applications. In particular, this is possible due to the flexible nature of the click elements and the pins, which makes it possible to detach external pins with the necessary (conscious) manipulation, and thus gives the pins located more to the inside the necessary freedom of movement to be detached. With this version, it is not or hardly possible that the click elements can take on a curved shape. Again, it is noted that some adaptations/alterations can be applied to enable curved shape connections for the fastener, such as extending inter-pin distance along a first axis and/or heating the carriers before connection, as mentioned previously.

According to another aspect of the invention, the two click elements may be identical in a pattern when hooked together. The center points of the pins are the same distance from each other according to the same pattern and arrangement. When hooking in the two click elements, the two click elements are preferably rotated 45° in relation to each other before pressing them together. Some pins are not or hardly pushed away from each other, and other pins push the opposing pins away from each other to a large or lesser extent. In this version, it is that the click elements can take on a curved shape. An additional feature is that the click elements can be connected in a stepless way.

Preferably, the dimensions of the pins of the click elements are substantially the same (similar width and length), although this may differ. For example, you can opt for thicker pins on one click element and thinner pins on the other, or even a mix according to a predetermined pattern, although the latter is less preferable as the two click elements must be placed more accurately in relation to each other for a good link.

According to another aspect of the invention, the materials of the click elements can be made up of a uniform material such as a plastic such as LDPE, PLA, PVC, EVA, Z-PVC, PU, TPE, TPV, without having an exhaustive effect. Moreover, these can be hard, flexible, or semi-flexible.

But other materials, such as carbon, steel, copper, etc, are also possible. These may or may not be flexible.

Also, the click elements that can be clicked together can be different in material.

According to another aspect of the invention, the materials of the click elements may be constructed from a composite material such as a plastic base combined with a steel band, a plastic base combined with steel pins, a steel base with plastic pins, or other possible variants.

According to another aspect of the invention, the basis of the present invention can be further supplemented with a hook connection. This hook connection has the function of blocking at least one side of the connection. The hook connection can be composed of a pin with a sphere or other widening on the one click element and an opening in the base plate. The opening in the other click element is provided so that the sphere of the pin can pass through smoothly and is also provided with an offshoot of the opening that is narrower than the opening through which the sphere can pass. After the sphere has been applied through the opening, the one click element is shifted relative to each other the other click element so that the sphere is positioned behind the narrower opening so that the two click elements are locked with each other. Since this connection is relatively weak, the two click elements are applied together according to the techniques described in the present invention. In a setup where the pins of one of the click elements are pushed through a fabric, all pins of this click element are pushed through the meshes of the fabric, whether or not including the pins provided with the spheres. The openings provided in the other click element are applied over the spheres and blocked by means of a pulling or pushing movement. Then the two click elements are pressed together. When tightening the fabrics in an opposite movement, an outward pressure will be applied to the pins of the click elements. The hook connection will absorb this pressure so that the pins of the different click elements remain hooked together and can therefore absorb high lateral forces. The crochet technique described above can be replaced by alternatives that have the same result within the intended objective.

According to another aspect of the invention, the dimensions of the two click elements are different in size. For example, the thickness of the different base plates can differ from each other, so that you get, for example, a click element that is quite stiff in which a more flexible click element can be clamped. But the click element's length and/or width can also vary. So, for example, several smaller click elements can be placed on a larger click element.

In an alternative aspect, the dimensions, or at least the thickness, are substantially the same for both click elements.

The dimensions of the pins themselves can also be different from each other. This can be compared to the different click elements, but also within the same click element, different sizes, shapes, numbers, and versions of the pins can be possible. The recesses on the pins can also be different with the different click elements but also within the same click element.

In a certain version of the present invention, the attachment between the different click elements uses a mix of attachment intensity in which the pins of the different click elements interact with each other in different places differently. By distributing the pins unordered over the base plate, a configuration can be created in which the click elements are clicked together at any place and/or at a random angle, whereby enough pins then apply pressure to each other to obtain a sufficiently strong connection.

In a certain version of the present invention, the attachment between the different click elements uses a mix of attachment intensity in which the pins of the different click elements interact with each other in different places in a different way. By dividing the pins over the base plate in an orderly but not symmetrical and/or linear way, a configuration can be created in which the click elements are clicked together at any place and/or at any angle, whereby enough pins then apply pressure to each other to obtain a sufficiently strong connection.

According to another aspect of the invention, the click elements can be provided with pins on both sides of the base plates. Another possible version is that the base plate is provided with pins on one side and on the other side a device to connect with another material where a different technique is needed, such as barbs, glue connection, screw connection, clamp connection, and other possible known connection techniques.

According to another aspect of the invention, the base of the click element may be part of a tool or other instrument. For example, the click element can be integrated into a clamping plier or other clamping mechanisms where the jaws of the tool or instrument is equipped with the pins as described in the present invention. But other parts such as a profile or a tube can also be provided with the described pins.

According to another aspect of the invention, the pins have the following possible shapes in terms of transverse cross-section, rectangle, square, round, polygon, or other possible geometric shapes. The shape may possibly be arbitrary in shape.

All sides of the pin are preferably provided with recesses to make the engagement in the opposite pin as efficient as possible.

The combination of recesses and protrusions can come in the execution of: barbs, squares, triangles wherein the flat side is preferably arranged so that it hooks on the flat side of the opposite pin, rib shapes wherein the side is made up of layered protrusions, this with a similar effect as in 3D printing, recesses in any shape, protrusions in random shape and other possible shapes that allow the hooking of the two opposing pins. Another possible version is that the pins have a rough surface so that the pins experience more resistance when they slide over each other, and thus a more significant clamping effect is obtained.

According to another aspect of the invention, the pins of the opposing click elements can be permanently connected to each other by using an adhesive bond. This can be by adding external glue or heating the click elements so that the pins merge. A variant of this is to obtain a semi-permanent adhesive bond by using external glue with a limited adhesive strength or to determine the pins' material so that these spiked ones can melt into each other.

The operation:

The principle of the invention is to clamp the pins by applying two click elements that are provided with pins by moving them in the opposite direction toward each other. Here the pins push laterally against each other, creating a clamping effect.

There are two main configuration techniques:
1) here, a random curved arrangement is possible
   Pins are pushed away in all directions
   Preferably, the click elements used are identical but can also be variable
2) a random curved arrangement is not possible

The click elements are preferably identical, depending on the version (sometimes the pins of the one click element must be longer than the pins of the other click element.

Only the curved shape is possible if the pins are further apart in an ordered and proportional way than the pins of the other click element, and this is only in the x-direction and not in the Y direction, for example

Possible applications of the present invention without wanting to work exhaustively are:

Connecting bandages or bandages where, according to a preferred embodiment form, the pins of one click element are longer than the other. The click element with the longer pins is pressed through the bandage. For this specific version, it is preferable to use a bandage with perforations wherein the central point of the perforations is equal to the central points of the pins applied by the bandage. The second click element is connected to the bandage on the pinless side, preferably at the end of the bandage. This connection can be made by a melting connection in which the bandage is fused in the click element, but it can also be done via a glue connection, a connection with barbs, or another connection.

Another possible application is a connection for a walking accessory such as a shoe. The hook and loop fastener technique is already frequently used in shoes to replace and/or supplement the well-known laces. The disadvantage of the hook and loop fastener technique is that over time it becomes less efficient in the adhesive force and that dirt can drastically reduce the operation of the hook and loop fastener. The aforementioned disadvantages can be eliminated by applying the present invention's fastening technique. For this application, it is preferable to use the version in which the attachment can take on a curved shape.

Other possible applications without wanting to enumerate exhaustively are belt connections, tent connections and fences, classic wall connection hanging of hooks mirrors and related ones, fixing of or to window screens (the mesh stucture is ideal for coupling with the carriers), holding seat upholstery in place, fixing mats, and the like.

### DESCRIPTION OF THE FIGURES

The following description of the figures of specific embodiments of the invention is:

Merely exemplary in nature and is not intended to apply or use the present teachings. In the drawings, corresponding reference numbers indicate similar or corresponding parts and characteristics.

FIG. 1: is a perspective view of five possible pin versions

FIG. 2: is a view in perspective of two possible pin versions in opposite arrangement

FIG. 3: is a view in perspective of pins of opposing click elements that interlock with the pins of the different click elements positioned at the same center distance from each other, but the pins of one engagement click element are rotated 45° in relation to each other the other engagement click element.

FIG. 4: is a top view of a principle arrangement of opposing click elements positioned next to each other where the pins of the different click elements are positioned at the same center distance from each other, but the pins of one engagement click element are rotated 45° in relation to each other the other engagement click element.

FIG. 5: is a top view of a principle arrangement of opposing click elements that interlock with the pins of the different click elements positioned at the same center distance from each other, but the pins of one engagement click element are rotated 45° in relation to each other the other engagement click element.

FIG. 6: is a perspective view of pins of opposing click elements that are identical in structure, but where the two click elements are rotated 45° in relation to each other.

FIG. 7: is a top view of pins of opposing click elements that are identical in structure, but where the two click elements are rotated 45° in relation to each other.

FIG. 8: is a top view of a principle arrangement of opposing click elements positioned next to each other where the pins of the opposing click elements are identical in structure but where the two click elements are rotated 45° in relation to each other.

FIG. 9: is a top view of a principle arrangement of opposing click elements that interlock in which the pins of the opposing click elements are identical in structure but where the two click elements are rotated 45° in relation to each other.

FIG. 10: is a view in perspective of a click element equipped with blocking pins along one side of the click element in the form of pins with a sphere and another click element equipped with recesses in which the pins with sphere can be locked.

FIG. 11: is a view in perspective of a click element that is additionally equipped with blocking pins along two sides of the click element in the form of pins with a sphere and another click element that is additionally equipped with recesses in which the pins with sphere can be locked

FIG. 12: is a view in perspective of a click element that is additionally equipped with blocking pins along one side of the click element in the form of pins with a sphere and another click element that is additionally equipped with recesses in which the pins with sphere can be locked where the pins of the click element, which is equipped with the blocking pins, is positioned through the openings of a material and the other click element, which is provided with the recesses, is connected to material along the side where no pins are provided.

FIG. 13 is a view in perspective of a version in which two click elements are connected by a bridge connection in an open position. The pins of the different click elements are positioned at the same center distance from each other, but the pins of one engagement click element at 45° are rotated in relation to each other the other engagement click element. The single-click element is also equipped with an eye design.

FIG. 14: is a view in perspective of a version in which two click elements are connected by a bridge connection in a closed position. The pins of the different click elements are positioned at the same center distance from each other, but the pins of one engagement click element at 45° are rotated in relation to each other the other engagement click element. The single-click element is also equipped with an eye design.

FIG. 15: is a view in perspective of a performance in which the click element is combined with a foil.

### Components

1. Pin with double barb: the description refers to a pin with a square shape in the base, equipped with 2 ribs wherein the bottom of the ribs is the shape of a barb.
2. Single rib pin: the description refers to a pin that has a square shape in the base and is equipped with one rib wherein the bottom of the rib has a flat bottom
3. Double rib pin: the description refers to a pin that has a square shape in the base and is equipped with two ribs wherein the bottom of the ribs has a flat bottom
4. Triple rib pin: the description refers to a pin that has a square shape in the base, is equipped with three ribs wherein the bottom of the ribs has a flat bottom
5. Rib: these are the protrusions on the pins that preferably connect to the ribs of the opposite pins, depending on the execution of the ribs.
6. Click element one: this is the combination of the base plate and pins
7. Click element two: this is the combination of the base plate and pins, wherein the pins are in the same place but are rotated 45° compared to click element 1
8. Click element with locking pins along one side: this is a click element wherein extra blocking pins are provided along one side with the function to block the opposite click element
9. Click element with cutouts on one side: this is a click element wherein cutouts are provided along one side with the function to block the opposite click element
10. Click element with locking pins on two sides: this is a click element wherein extra blocking pins are provided along two sides with the function to block the opposite click element
11. Click element with cutouts on two sides: this is a click element wherein extra blocking pins are provided along two sides with the function to block the opposite click element
12. Fabric with cutouts: this is a preferably woven fabric that has openings through which the pins of the click element fit. Preferably, the center points of these openings are as far apart as the center points of the pins of the click element that is pushed through them. Also, the openings in the fabric are the same size or slightly larger than the largest lateral distance from the pin that must pass through it.
13. Click element with the eye: this is a combination of two opposing click elements that are connected using a bracket and wherein an extra protrusion is provided with an extra opening
14. Blocking pins: this is formed by the combination of a pin with a sphere
15. Cutout pin: These are the recesses in the pin in which the ribs of the opposite pin fit.
16. Blocking cutout: This is the cutout in the base plate through which the sphere of the blocking pins fits.
17. Pin general: this is the pin of the click element that clamps into the opposite pin. It can take any form as described in this document.
18. Fabric/material without cutouts: this is a fabric or material in which preferably no pins are pushed through and is applied to the side of the click element that does not contain pins.
19. Eye: this is an extra opening in the base of one of the click elements
20. Top: this is the top of the pin that is preferably oblique and/or rounded in shape
21. Base plate: this is the plate of the click elements on which the pins are provided.
22. Bracket: this forms the bridge between 2 click elements that form part of the execution of a click element with an eye. This is preferably flexible.
23. Extension: this is an extension of one of the elements in which an opening is also provided through which a suspension device is formed
24. Sphere: This is the bulge to block the blocking pin behind the base of the opposite element.
25. Foil: this is a combination with the base plate so that the element can be attached via a suction cup function

Advantages

The present invention is mainly a competitor for the hook-eye connection and, more specifically for the version known under the brand name Hook and loop fastener.

It has the following advantages

Minimal noise: With the traditional hook-eye connection, loosening the joint causes a significant noise due to pulling the hooks from the loops. This is not the case with the present invention.

Washable and hygiene: with the traditional hook-eye connection, dirt sticks to the hooks, and dirt creep into the eyes. In the execution of the present invention, no dirt sticks, and is also very easy to clean, both manually and mechanically. The click elements can also be disinfected easily, making it suitable for use in the food and medical sectors. But also for swimming pools, playgrounds, hospitals, etc.

Environmentally friendly: the click elements can be constructed from one material, and this material can be an environmentally friendly material such as bioplastic. This makes it not only environmentally friendly but also relatively cheap to produce.

Adaptable: with most versions in plastic, it is also possible to cut and/or cut the click elements to size.

High forces: the specific structure of the click elements means that the lateral forces that can be absorbed are much higher than the traditional hook-eye connection. This makes the present invention suitable for heavier transport and vehicles and for more extreme applications.

Glueable: since the click elements in most cases do not contain a woven fabric, and the click elements can also be glued together.

Cheaper production: The simple construction of the click elements means that the production cost is much lower than with the traditional hook-eye connection, especially in the versions wherein the opposite click elements are identical or almost identical.

Reliability: with the traditional hook-eye connection, hooks regularly break off after multiple uses. This does not play a role in the present invention

Additional advantages are that most versions, according to the current invention, do not immediately stick. So it does not hurt if you hold the pins or walk over them and does not stick to the clothes if you wash them together, for example.

### DETAILED DESCRIPTION OF THE INVENTION

The present invention relates to a composite fastener, the composition consisting of click elements. The present invention also relates to click elements for said assemblies and methods for constructing a composite fastener.

Unless otherwise defined, all terms used in revealing the invention, including technical and scientific terms, have the meaning as generally understood by one of the ordinary skills in the field to which this invention belongs. Through further guidance, term definitions have been included to better appreciate the present invention's teachings.

As used herein, the following terms have the following meanings:

“Over” as used herein, referring to a measurable value such as a parameter, an amount, a duration, and the like, is intended to allow variations of +1-20% or less, preferably +1-10% or less, rather +/−5% or less, even more preferably +/−1% or less, and with even more preference 41-0.1% or less of and of the specified value, to the extent that such variations are suitable to perform in the revealed invention. However, it should be clear that the value to which the modifier refers “approximately” is itself also specifically stated. “Provided”, “consisting of” and “includes” and “consisting of” as used herein are synonymous with “comprise”, “comprising” “comprises” or “contain”, “containing” “contains” and are inclusive or open terms that specify the presence of what follows, for example, a component and excludes the presence of additional, unrecited components, characteristics, click elements, members, steps, known in the technique or revealed therein.

Furthermore, the terms first, second, third, and the like in the description and in the claims are used to distinguish between similar click elements and are not necessary for: describing a sequential or chronological order unless otherwise indicated. It is understandable that the terms thus used are interchangeable under the right circumstances and that: the embodiments of the invention described here may be in sequences other than those described or illustrated herein.

The recitation of numerical ranges by endpoints includes all numbers and fractions housed within that range and the endpoints mentioned.

While the terms ‘one or more’ or ‘at least one, such as one or more or at least one member(s) of a group of members, is necessarily clear, by further example, the term includes a reference to one of the said members, or to two or more of the said members, such as, for example, ≥3, ≥4, ≥5, ≥6 or ≥7, etc. of said members, and to all said, members.

All references cited in this specification are hereby incorporated in their entirety by reference. In particular, the doctrine of all references specifically referred to here is to be incorporated by reference.

Unless otherwise defined, all terms used in revealing the invention, including technical and scientific terms, have the meaning as generally understood by one of the ordinary skills in the field to which this invention belongs. Through further guidance, definitions for the terms used in the description are included in the present invention's teachings. The terms or definitions used herein are given solely to assist in understanding the invention. Reference in this specification to “one embodiment” or “an embodiment” means that a particular feature, structure, or feature described in connection with the embodiment is included in at least one embodiment of the present invention.

So, the appearances of the expressions “in one composition” or “in a composition” in different places in this specification do not necessarily all refer to the same version but can. In addition, the special features, structures, or characteristics can be combined in any appropriate way, as would be clear to a professional from this description, in one or more embodiments.

In addition, although some embodiments described herein include some but not other features included in other versions, combinations of features of different versions are intended to fall within the scope of the invention and constitute different performances, as will be understood by the craftsman.

For example, in the following claims, any of the claimed embodiments can be used in any combination.

The terms “first click element” and “second click element” refers to two types of click elements, which can still be of the same type.

When using the x, y, and z-axis as an indication, the example, wherein the click element is arranged horizontally, refers to the x-direction as the horizontal longitudinal direction. i.e., the direction on which the forces are applied. The y-direction stands for the width in the horizontal direction of the click element, and the z-axis is the vertical direction in which the click elements are moved to or from each other.

When defining the parts, such as the pins, gradients can be used to determine the shape of the pins according to the z-direction. This is preferably between 0 and 1°, but can also work with gradients between 1 and 30°, with possibilities up to 5°, and depending on the implementation of combination recesses and protrusions of the pins can, the shape of the pins themselves or a combination of shapes and/or different materials of pins, the slope of the pins can be ≥5° and the gradients can even be negative.

When defining the composition of the click elements wherein the arrangement of the pins of one element in relation to the other element is determined, it is preferably 45° but can also be larger than 45°. Depending on the design and/or composition of the elements, the shape of the pins themselves, or a combination of shapes and/or different materials of pins, the rotation difference between them can be between 0 and 180°.

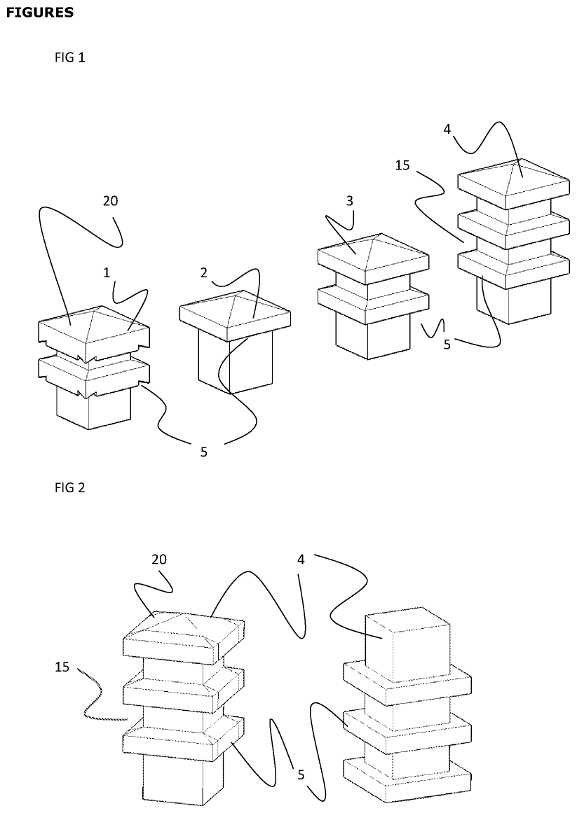

The basis of the invention is the principle whereby the pins 17 of opposite click elements are provided with recesses wherein the pins 17 exert a certain pressure on each other if the click elements are pressed on each other and the opposite pins 17 touches each other. FIG. 1 shows some possible versions of pin 17 that allow efficient clamping. The preferred shape is a square as a basic shape that runs very slightly conical upwards, in the z-direction, to enable production via spray molding. Preferably, the angle of the conical shape is less than 1°. FIG. 1 shows four possible embodiments. The most leftside pin 1 has double ribs 5 that have the shape of a barb at the corners of it. These types of pins 17 are the most efficient but are quite more difficult to manufacture. The second pin 2 is provided with a single rib 5 with a flat bottom, the third pin 3 with double ribs 5 with a flat bottom 3, and the fourth pin 4 with a triple rib 5 with a flat bottom. The versions where the ribs 5 are provided with a flat bottom are easier to produce than the ribs 5 that has the shape of a barb. When applying the opposite click elements, the ribs 5 hook together with their flat side. Note that the barbs can also be provided in the second and fourth pin versions. FIG. 2 shows single pins 4 with triple ribs 5 with a flat bottom arranged in the opposite direction.

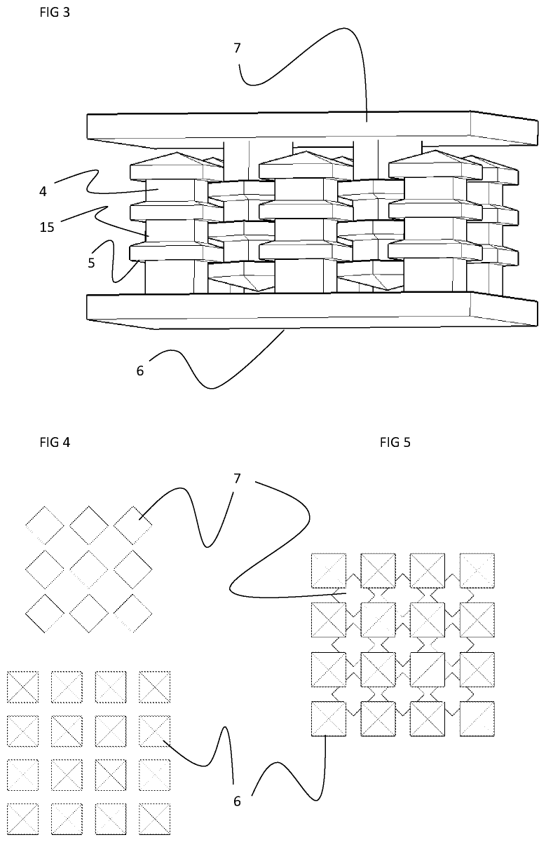

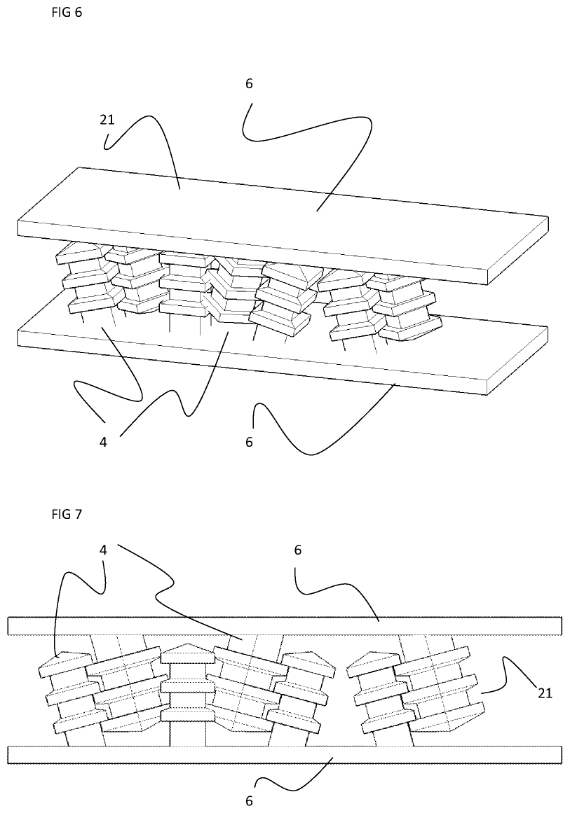

In FIG. 3, two opposing click elements interlock with the pins 4 of the different click elements positioned at the same center distance from each other, but pins 4 of one engagement click element 7 are rotated 45° in relation to the other engagement element 6. The pins 4 of both click elements are equipped with three ribs 5. When engaging, the protrusions, which form the ribs 5 of the pins 4, are positioned in the recesses 15 of the opposite pins 4. FIG. 4 shows a principle representation of the two click elements in which the pins of one click element 7 is rotated 45° in relation to the other click element 6 and positioned towards each other. FIG. 5 shows the basic components when the two click elements are clicked together, as shown in FIG. 3. In this version, the pins are square in shape so that the angular sides of the pins 4 push into the middle of the long sides of the opposite pins 4.

In FIG. 6 and FIG. 7, replaced opposite but identical click elements 6 interlocks with the two click elements are rotated 45° in relation to each other. The pins 4 of both click elements are equipped with three ribs 5. When taking hold, the protrusions, which form the ribs 5 of the pins 4, are positioned as much as possible in the recesses of the opposite pins 4 but more randomly. FIG. 8 shows a principle representation of the two click elements, in which one click element 6 is rotated 45° in relation to the other click element 6 and positioned towards each other. FIG. 9 shows the basic composition if the two click elements 6 are clicked together, as shown in FIGS. 6 and 7. In this version, pins 4 are square in shape, but the sides and corners interlock in a random way. The chamfered sides of the top of the pins cause the pins to lie next to each other and interact, but this is done fairly randomly, depending on the desired distance and the bending of the base plates.

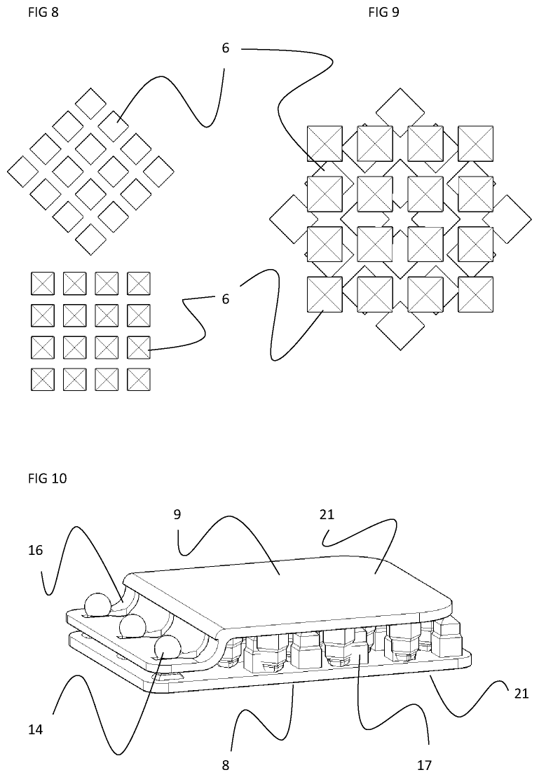

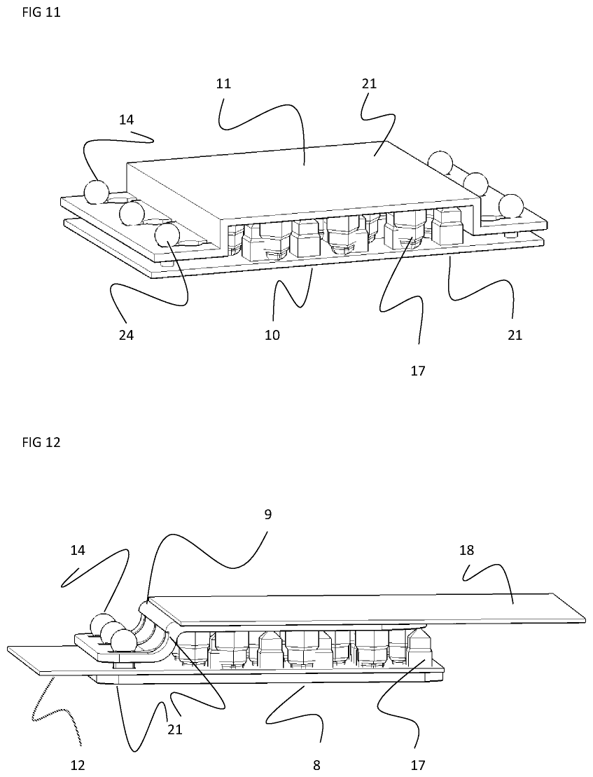

In some situations, it may be necessary to provide an additional blockage. For example, if the fastener is used to attach a bandage. As shown in FIG. 12, on the base plate 21 of element 8, which is equipped with blocking pins 14, there is a substance 12 with openings. Because of this fabric 12, both the pins 17 and the blocking pins 14 are pushed so that the fabric 12 touches the base plate 21. The other click element 9 that is equipped with the blocking recess 16 is the fabric 18 on the outside of the click element 9. The connection between the click element 9 and the fabric 18 of, for example, the bandage can be done by means of glue, but also, for example, by providing barbs or a combination of these. As shown in FIG. 10, the two click elements 8 and 9 are clicked together with the blocking pins 14 fitting through the blocking recess 16. When the two click elements 8,9 click together, the blocking pins 14 are first placed in the blocking recesses 16 at a certain angle. The blocking recesses have a shape that is defined so that the sphere 24 of the blocking pins 14 fits through them, with a spur that narrows so that the sphere 24 remains behind the base plate 21 of the click element 9. As soon as the sphere 24 has reached the final position of the constriction, the two click elements 8, 9 can be clicked together in a similar way as described above. A variant of this is shown in FIG. 11. A two click elements 10, 11 that fit together are equipped on both sides with a blocking device consisting of the combination blocking pins 14 and blocking recesses 16 wherein the operation is similar to that described in FIG. 10. However, when applying the blocking pins 14 in the blocking recesses 16, the base plate 21 of one click element 10 must be able to be bent to move the blocking pins 14 through the openings of the blocker recesses 16. When the pins 17 are clicked together, the blocking pins 14 will automatically move to their endpoint in the blocking recesses 16.

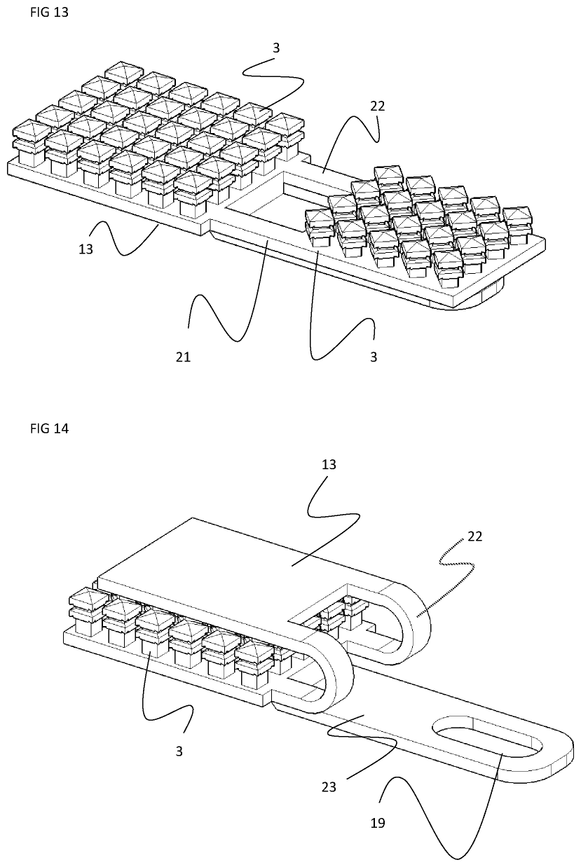

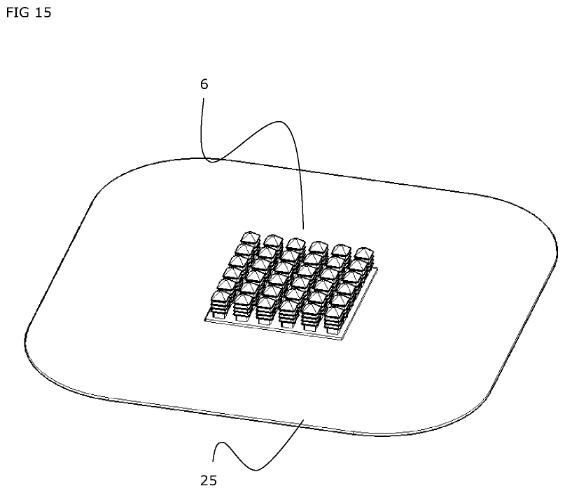

Many applications and variants are possible regarding the clicking together of the two click elements as a fastener. FIGS. 13 and 14 describe a variant in which the base plates 21 of the different click elements 13 are connected by a flexible bracket 22. When folding the two opposing click elements 13, the opposite pins 1 interlock with the pins 1 of the different click elements 13 positioned at the same center distance from each other, but the pins of one part of the engagement click element 13 45° are rotated in relation to the other part of the engagement element 13. The pins 1 of the two parts of the click element 13 are equipped with two ribs 5 of the barb principle 1. When engaging, the protrusions, which form the ribs 5 of the pins 1, are positioned in the recesses of the opposing pins 1. One part of the click element is equipped with an extension 23 in which an eye 19 is provided so that a suspension device is formed. This is preferably composed of the same material as the base plates 21 of the click element 13.

An additional preferred embodiment, as shown in FIG. 14, consists of a click element 6 that is extended with a foil 25. This allows the click element 6 to be attached to a smooth surface such as a tile. The air is pushed from under the foil 25, creating a suction effect and the click element sticking to the wall. Another object equipped with an opposite click plate 7 can be attached to the first click element 6. The advantage of such a version is that the whole side of the click element 6 and foil 25 can be built from 1 material, which greatly simplifies the production.

1. A composite fastener comprising a first carrier and a second carrier, wherein the first and second carriers each comprise a coupling surface and wherein a plurality of pins are provided on the coupling surface in a regular grid pattern.
wherein the pins comprise at least one anchoring segment along the longitudinal axis with a radius greater than a radius of an underlying segment of the pins, and optionally a greater radius than a radius of an overlying segment of the pins: wherein the pins are made up of a flexible material;
and wherein at rest, the pins of the first carrier are distanced from each other such that the anchoring segments of the pins of the first carrier at rest have a distance between them which defines a free space between the anchoring segments in the plane parallel to the first carrier where a transverse cross-section of the anchoring segments of the pins of the second carrier does not fit in, and wherein the underlying segments of the pins of the first carrier at rest define a space between the underlying segments in the plane parallel to the first carrier where a transverse cross-section of the anchoring segments of the pins of the second carrier does fit in, in a way that when the first and second carrier are brought together with the coupling surfaces facing each other, the pins hold each other clampingly.

2. The composite fastener according to claim 1, wherein the neighboring pins have an interaxial distance of at least 2.0 times and less than (2+√2) times the minimum radius of the anchoring segments.

3. The composite fastener according to claim 1, wherein the anchoring segment has a minimum radius lower than the maximum radius of the overlying segment and optionally of the overlying segment.

4. The composite fastener according to claim 1, wherein the anchoring segments have a square transverse cross-section along the longitudinal axis.

5. The composite fastener according to claim 1, wherein the pins of the first carrier are positioned in a first orientation relative to the axes of the grid pattern of the first carrier, and the pins of the second carrier are positioned in a second orientation relative to the axes of the grid pattern of the second carrier, wherein the first orientation is rotated approximately 45° in relation to the second orientation.

6. The composite fastener according to claim 1, wherein the first and/or second carrier is flexible.

7. The composite fastener according to claim 1, wherein the material of the pins, the material of the first carrier, the material of the second carrier, or some combination thereof comprises plastic.

8. The composite fastener according to claim 1, wherein the first carrier and the pins of the first carrier are single-piece and/or the second carrier and the pins of the second carrier are single-piece.

9. The composite fastener according to claim 1, whereby the first and second carriers are flexibly connected to each other.

10. The composite fastener according to claim 1, wherein the pins of the first and/or of the second carrier comprise two or more anchoring segments with a greater radius than a radius of a segment of the pins between the two anchoring segments, and with a radius greater than a radius of a segment lying on the other side of the anchoring segment than the intermediate segment of the pins.

11. The composite fastener according to claim 1, wherein between the anchoring segments comprise an upper flank, directed away from the coupling surface, and wherein the upper flank has an increasing.

12. (canceled)

13. The composite fastener according to claim 1, wherein between the anchoring segments and a directly successive underlying segment, a lower flank extends, wherein the lower flank forms an angle with the longitudinal axis of the pin between 75° and 90°.

14. (canceled)

15. The composite fastener according to claim 1, wherein the pins have a structure from the link surface with sequentially an underlying segment, an anchor segment, an intermediate segment, and a second anchoring segment, wherein the underlying and intermediate segments have substantially the same transverse cross-section, and wherein the first anchoring segment and the second anchoring segment have substantially the same transverse cross-section.

16. The composite fastener according to claim 1, wherein the anchoring segments have a radius of at least 10% greater than the radius of the other segments.

17. The composite fastener according to claim 1, wherein the pins of the first and second carriers are substantially identical in shape and dimensions.

18. The composite fastener according to claim 1, wherein the pins have a maximum radius of 2.5 mm.

19. The composite fastener according to claim 1, wherein the pins have a minimum radius of 0.25 mm.

20. The composite fastener according to claim 1, wherein the pins have a square transverse cross-section along the longitudinal axis, and wherein the sides of the square transverse cross-section are either parallel to the axes of the square grid pattern for both carriers, either for one carrier the sides of the square transverse cross-section form an angle of approximately 45° to the axes of the square.

21. The composite fastener according to claim 1, wherein the interaxial distances between neighboring pins of the first carrier and the interaxial distances between neighboring pins of the second carrier are substantially equal.

22. The composite fastener according to claim 1, wherein the anchoring elements at the bottom comprise at least one, preferably 2, 3, 4 or more, barb-shaped elements.
